(19) United States
(12) Patent Application Publication
(10) Pub. No.: US 2026/0329147 A1
(43) Pub. Date: Oct. 22, 2026

(54) IRIS MODULE AND CAMERA MODULE INCLUDING IRIS MODULE

(71) Applicant: SAMSUNG ELECTRO-MECHANICS CO., LTD., Suwon-si (KR)

(72) Inventors: Min Jeong KANG, Suwon-si (KR); Jae Sung OH, Suwon-si (KR)

(73) Assignee: SAMSUNG ELECTRO-MECHANICS CO., LTD., Suwon-si (KR)

(21) Appl. No.: 19/438,915

(22) Filed: Jan. 2, 2026

(30) Foreign Application Priority Data
Apr. 16, 2025 (KR) 10-2025-0049217

(51) Int. Cl. G03B 9/06

(52) U.S. Cl. CPC G03B 9/06

(57) ABSTRACT

An iris module includes a base, a rotator disposed on one side of the base, a plurality of blades disposed on one side of the rotator and defining an entrance aperture, and a first spacer disposed on one side of the plurality of blades and coupled to the rotator. The rotator includes a plurality of guide protrusions to which the plurality of blades are coupled, respectively, and the first spacer overlaps some guide protrusions, among the plurality of guide protrusions, in an optical axis direction.

### CROSS-REFERENCE TO RELATED APPLICATIONS

This application claims the benefit under 35 USC 119(a) of Korean Patent Application No. 10-2025-0049217 filed on Apr. 16, 2025, in the Korean Intellectual Property Office, the entire disclosure of which is incorporated herein by reference for all purposes.

### BACKGROUND

### 1. Field

The present disclosure relates to an iris module and a camera module including the same.

### 2. Description of the Background

Recently, camera modules have been used in portable electronic devices such as smartphones, tablet PCs, and laptop computers.

A camera module may include an iris module adjusting an amount of light incident within the camera module.

An iris module may have a structure in which a blade and a spacer are sequentially stacked on a moving pin provided in a rotator.

However, the iris module may be open on an upper side of the moving pin, and thus there may be a risk that the blade and the spacer may be detached from the moving pin.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an iris module includes a base, a rotator disposed on one side of the base, a plurality of blades disposed on one side of the rotator and defining an entrance aperture, and a first spacer disposed on one side of the plurality of blades and coupled to the rotator. The rotator includes a plurality of guide protrusions to which the plurality of blades are coupled, respectively, and the first spacer overlaps some guide protrusions, among the plurality of guide protrusions, in an optical axis direction.

The first spacer may include a plurality of coupling holes formed in positions corresponding to the plurality of guide protrusions.

The number of the plurality of coupling holes may correspond to the number of the plurality of guide protrusions, or may be less than the number of the plurality of guide protrusions.

The plurality of coupling holes may include a first coupling hole having a first diameter, and a second coupling hole having a second diameter. The second diameter may be greater than the first diameter and a diameter of each of the plurality of guide protrusions.

The first spacer may include an extension portion extending from the first spacer to one side of the guide protrusion, and the extension portion may overlap a portion of the guide protrusion in the optical axis direction.

The plurality of coupling holes may further include a third coupling hole defined by the extension portion and having a third diameter, and the third diameter may be less than the first diameter and the diameter of each of the plurality of guide protrusions.

Among the first coupling hole, the second coupling hole, and the third coupling hole, the third coupling hole may be provided in the greatest number, and the second coupling hole may be provided in the smallest number.

The extension portion may be formed to cover the guide protrusion entirely.

The iris module may further include a cover disposed on one side of the first spacer, wherein a distance between the cover and the first spacer in the optical axis direction may be less than a thickness in the optical axis direction of each of the plurality of blades.

The plurality of blades may include an upper blade set and a lower blade set, disposed at different heights in the optical axis direction, and the first spacer may be disposed on one side of the upper blade set.

The iris module may further include a second spacer disposed between the lower blade set and the rotator.

The plurality of blades may be coupled to the base and the rotator, respectively, the rotator may be configured to be rotatable about an optical axis relative to the base, and the plurality of blades may be configured to adjust a size of the entrance aperture in response to rotation of the rotator.

In another general aspect, an iris module includes a base, a rotator supported by the base and configured to be rotatable, relative to the base, a plurality of blades coupled to the base and the rotator, respectively, and a first spacer coupled to the rotator and disposed to overlap the plurality of blades. The rotator includes a plurality of guide protrusions to which the plurality of blades and the first spacer are coupled, and the first spacer includes a plurality of coupling holes formed in positions corresponding to the plurality of guide protrusions and having different diameters.

The plurality of coupling holes may include a first coupling hole having a first diameter, a second coupling hole having a second diameter, and a third coupling hole having a third diameter. The second diameter may be greater than the first diameter and a diameter of each of the plurality of guide protrusions, and the third diameter may be less than the first diameter and the diameter of each of the plurality of guide protrusions.

A camera module may include the iris module, and an actuator including a lens module and configured to be movable in at least one direction among the optical axis direction and a direction perpendicular to an optical axis.

The iris module may be coupled to the actuator and configured to move together with the actuator.

Other features and aspects will be apparent from the following detailed description, the drawings, and the claims.

### BRIEF DESCRIPTION OF DRAWINGS

FIG. 1 is a perspective view of a camera module according to an example embodiment of the present disclosure.

FIG. 2 is a perspective view of an iris module separated from FIG. 1.

FIG. 3A is a perspective view of an iris module having a relatively small entrance aperture, and FIG. 3B is a perspective view of an iris module having a relatively large entrance aperture.

FIG. 4 is an exploded perspective view of an iris module according to an example embodiment of the present disclosure.

FIG. 5 is a perspective view of a driving portion of the iris module of FIG. 4.

FIG. 6 is a plan view of a ball rolling portion of the iris module of FIG. 4.

FIG. 7 is a perspective view of a yoke portion separated from a base of FIG. 4.

FIG. 8 is a diagram illustrating a direction of attractive force of the iris module of FIG. 4.

FIG. 9 is a plan view of a ball rolling portion and a guide groove in which the ball rolling portion is disposed.

FIG. 10 is a plan view of an iris module (with a cover omitted) according to an example embodiment of the present disclosure.

FIG. 11 is a cross-sectional view taken along line I–I' of FIG. 10.

FIG. 12 is a plan view of an iris module (with a cover omitted) according to another example embodiment of the present disclosure.

FIG. 13 is a cross-sectional view taken along line II–II' of FIG. 12.

FIG. 14 is a cross-sectional view of a modification of FIG. 12.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The present disclosure provides an iris module in which the risk of component detachment is reduced or eliminated, and a camera module including the same.

The present disclosure relates to a camera module, and more particularly, to a camera module mounted in a portable electronic device such as a smartphone or a tablet PC.

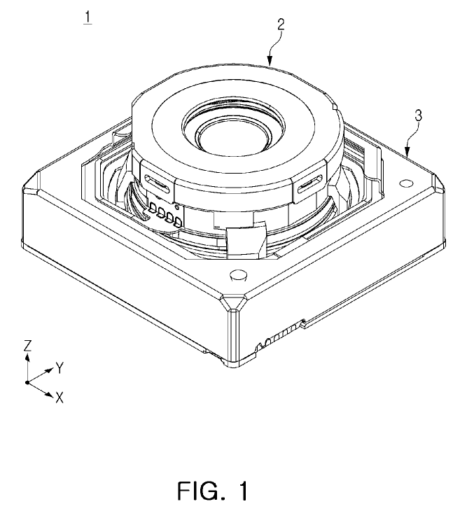

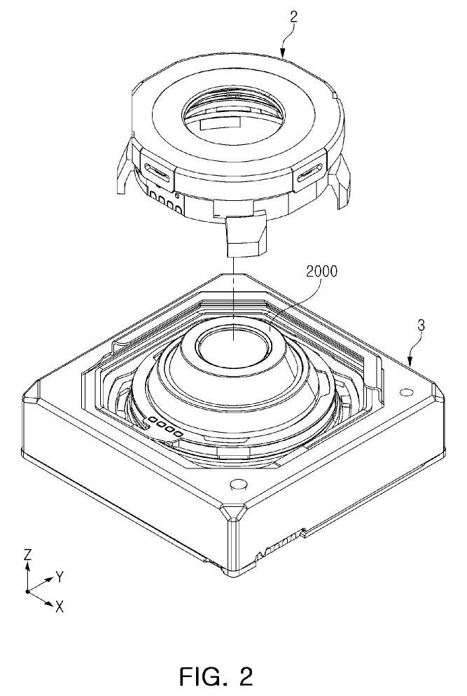

FIG. 1 is a perspective view of a camera module according to an example embodiment of the present disclosure, and FIG. 2 is a perspective view of an iris module separated from FIG. 1.

Referring to FIGS. 1 and 2, a camera module 1 may include an iris module 2 and an actuator 3.

The iris module 2 may adjust an amount of light incident on the camera module 1, and the actuator 3 may perform focus adjustment and image stabilization of the camera module 1.

In an example embodiment, the actuator 3 may include a lens module 2000. The lens module 2000 may move in an optical axis direction (Z-axis direction) by the actuator 3 during focus adjustment, and may move in directions (X-axis and Y-axis directions), perpendicular to an optical axis (Z-axis) during image stabilization.

The iris module 2 may be disposed on an upper side of the actuator 3 to adjust an amount of light incident on the lens module 2000 of the actuator 3.

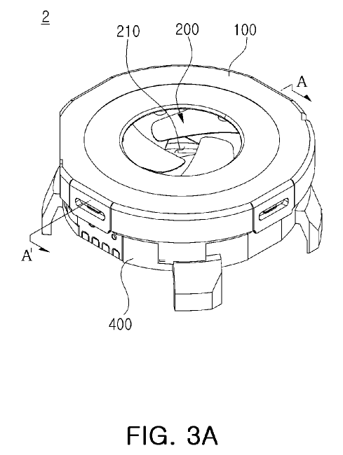

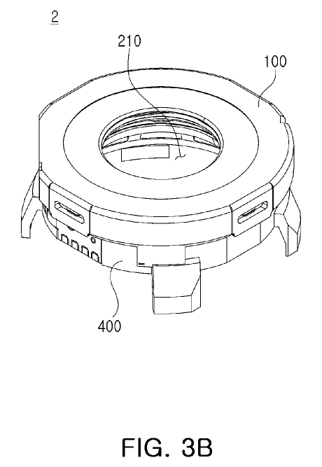

FIG. 3A is a perspective view of an iris module having a relatively small entrance aperture, and FIG. 3B is a perspective view of an iris module having a relatively large entrance aperture.

In an example embodiment, the iris module 2 may include an entrance aperture 210 through which light passes, and may be configured to adjust an amount of light incident on the lens module 2000 by changing a size of the entrance aperture 210.

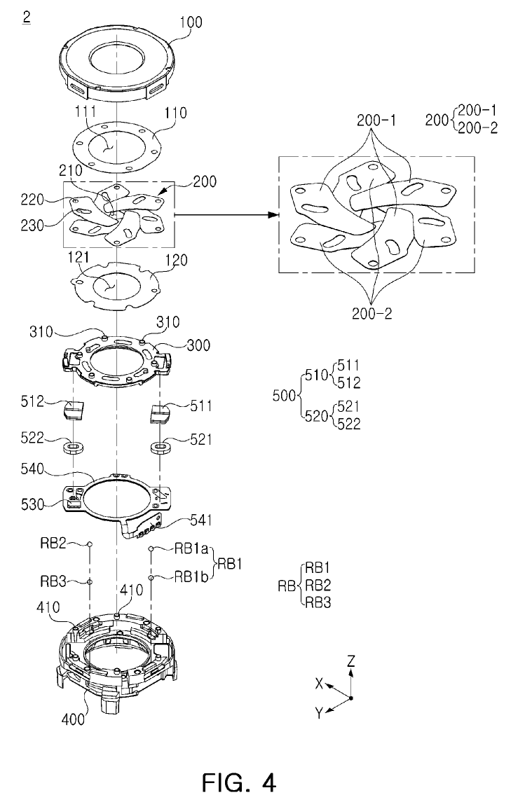

FIG. 4 is an exploded perspective view of an iris module according to an example embodiment of the present disclosure.

Referring to FIG. 4, the iris module 2 according to an example embodiment of the present disclosure may include a base 400, a rotator 300, a blade 200, and a driving portion 500 (hereinafter, an iris driving portion).

The base 400 may be coupled to the actuator 3 of the camera module 1. For example, the base 400 may be coupled to the lens module 2000. Accordingly, when the lens module 2000 moves, the iris module 2 may also move together.

The base 400 may be a movable member moving together with the lens module 2000 during focus adjustment and image stabilization of the camera module 1. Conversely, the base 400 may be a fixed member that does not move during operation of the iris module 2.

The rotator 300 may be spaced apart from the base 400 in the optical axis direction (Z-axis direction), and may rotate relative to the base 400. The rotator 300 may rotate about the optical axis (Z-axis) relative to the base 400.

A size of the entrance aperture 210 may be changed due to rotation of the rotator 300.

The blade 200 may be provided as a plurality of blades 200, and may form the entrance aperture 210.

In an example embodiment, the blades 200 may include six blades, and the six blades may be divided into three upper blades and three lower blades.

Three blades may form one set.

An upper blade set 200-1 and a lower blade set 200-2 may be disposed in the optical axis direction (Z-axis direction). Individual blades included in the upper blade set 200-1 may be disposed to be offset from individual blades included in the lower blade set 200-2. For example, one blade included in the upper blade set 200-1 may overlap two blades included in the lower blade set 200-2.

In another example embodiment, the number of blades 200 may be changed, and a form in which the blades 200 are disposed may also be changed according to the number of blades 200.

The blade 200 may define the entrance aperture 210. That is, in an example embodiment, the entrance aperture 210 may be defined by six blades.

A position of the blade 200 may be changed while rotating by driving force generated by the aperture driver 500. The size of the entrance aperture 210 may be determined according to the position of the blade 200.

The blade 200 may be coupled to the base 400 and the rotator 300.

The blade 200 may include a through-hole 220 passing through the blade 200 in the optical axis direction (Z-axis direction). The through-hole 220 may be formed at an outer end of the blade 200 and coupled to the base 400.

The base 400 may include a protrusion 410 protruding in the optical axis direction (Z-axis direction).

The through-hole 220 of the blade 200 may be coupled to the protrusion 410 of the base 400. The number of protrusions 410 may be equal to the number of blades 200 along a circumferential direction of the base 400. Accordingly, the protrusions 410 and the blades 200 may be coupled to each other, in a one-to-one correspondence.

The protrusion 410 may form a rotation axis of the blade 200. That is, the blade 200 may rotate using the protrusion 410 as a rotation axis, such that the through-hole 220 and the protrusion 410 may be firmly coupled to each other.

In addition, the blade 200 may include a guide hole 230 passing through the blade 200 in the optical axis direction (Z-axis direction). The guide hole 230 may be formed in a position spaced apart from a position of the through-hole 220.

The rotator 300 may include a guide protrusion 310 protruding in the optical axis direction (Z-axis direction).

The guide hole 230 of the blade 200 may be coupled to the guide protrusion 310 of the rotator 300. The number of guide protrusions 310 may be equal to the number of blades 200 along a circumferential direction of the rotator 300. Accordingly, the guide protrusions 310 and the blades 200 may be coupled to each other, in a one-to-one correspondence.

The guide hole 230 may have a length. Accordingly, when the rotator 300 rotates, the guide protrusion 310 may move within the guide hole 230, and the blade 200 may rotate using the protrusion 410 as a rotation axis.

The above description related to the blade 200 may be equally applied to all blades.

The iris module 2 according to an example embodiment of the present disclosure may further include a cover 100.

The cover 100 may be coupled to the base 400, and the blade 200 and the rotator 300 may be disposed in a space provided between the cover 100 and the base 400.

In addition, the iris module 2 according to an example embodiment of the present disclosure may include spacers disposed on upper and lower sides of the blade 200.

In an example embodiment, the first spacer 110 may be disposed between the upper blade set 200-1 and the cover 100.

Referring to FIG. 4, a first spacer (or top spacer) 110 may be disposed between the blade 200 and the cover 100, and a second spacer (or bottom spacer) 120 may be disposed between the blade 200 and the rotator 300.

The first spacer 110 may have a through-hole 111 through which light passes, and a peripheral portion of the through-hole 111 may overlap blades included in the upper blade set 200-1.

The through-hole 111 of the first spacer 110 may have a diameter greater than a maximum diameter of the entrance aperture 210 formed by the blade 200.

In an example embodiment, the second spacer 120 may be disposed between the lower blade set 200-2 and the rotator 300.

The second spacer 120 may have a through-hole 121 through which light passes, and a peripheral portion of the through-hole 121 may overlap blades included in the lower blade set 200-2.

The through-hole 121 of the second spacer 120 may have a diameter greater than the maximum diameter of the entrance aperture 210 formed by the blade 200. In addition, the through-hole 121 of the second spacer 120 may have a diameter less than that of the through-hole 111 of the first spacer 110.

The first spacer 110 and the second spacer 120 may have a surface coated with black color.

In addition, the first spacer 110 and the second spacer 120 may be coupled to the rotator 300. In particular, according to example embodiments of the present disclosure, the first spacer 110 may be firmly coupled to the rotator 300.

In the present disclosure, the first spacer 110 and the blade 200 may be prevented from moving upwardly and disengaging from the rotator 300 through a coupling structure between the first spacer 110 and the rotator 300. A detailed description related thereto will be provided below.

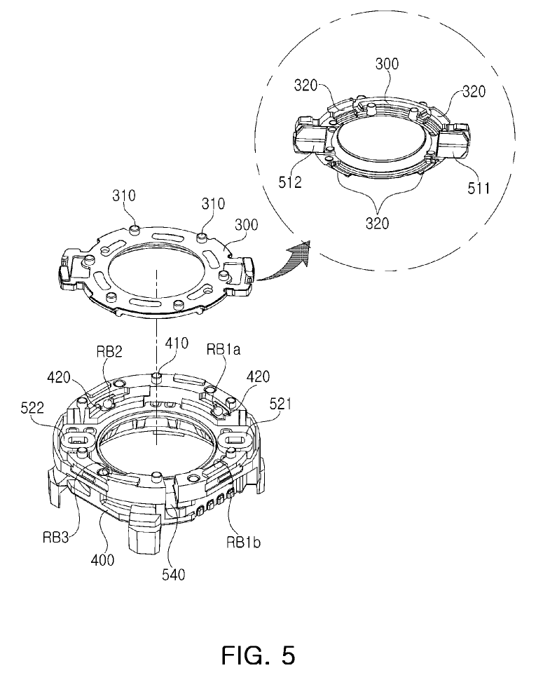

FIG. 5 is a perspective view of a driving portion of the iris module of FIG. 4.

The iris driving portion 500 may generate driving force for rotating the rotator 300. Due to rotation of the rotator 300, the guide protrusion 310 may move within the guide hole 230, and the blade 200 may rotate using the protrusion 410 as a rotation axis. Through such an operation, the size of the entrance aperture 210 defined by the blade 200 may be changed.

The iris driving portion 500 may include a magnet portion 510 and a coil portion 520 opposing each other in the optical axis direction (Z-axis direction).

The magnet portion 510 and the coil portion 520 may be disposed on the rotator 300 and the base 400. For example, the magnet portion 510 may be disposed on a lower surface of the rotator 300 toward the base 400, and the coil portion 520 may be disposed on an upper surface of the base 400 toward the rotator 300.

In an example embodiment, the magnet portion 510 may be a movable member moving together with the rotator 300, and the coil portion 520 may be a fixed member. In another example embodiment, positions of the magnet portion 510 and the coil portion 520 may be switched.

The magnet portion 510 may include a plurality of magnets spaced apart from each other. For example, the magnet portion 510 may include a first magnet 511 and a second magnet 512 disposed to oppose each other about the optical axis (Z-axis).

The coil portion 520 may include a plurality of coils spaced apart from each other. For example, the coil portion 520 may include a first coil 521 and a second coil 522 disposed to oppose each other about the optical axis (Z-axis). The first coil 521 may oppose the first magnet 511 in the optical axis direction (Z-axis direction), and the second coil 522 may oppose the second magnet 512 in the optical axis direction (Z-axis direction).

A surface of the first magnet 511, opposing the first coil 521, may have both an N pole and an S pole. For example, in a rotational direction of the rotator 300, a surface of the first magnet 511, opposing the first coil 521, may sequentially have an N pole, a neutral region, and an S pole. The second magnet 512 may also be configured in the same manner.

The first coil 521 and the second coil 522 may be disposed on the base 400 via a substrate 540. For example, the substrate 540 may be disposed on an upper surface of the base 400, and the first and second coils 521 and 522 may be mounted on one surface of the substrate 540 toward the rotator 300.

The substrate 540 may include an extension portion 541 extending from the upper surface of the base 400 to a side surface of the base 400. The extension portion 541 may be connected to the actuator 3 of the camera module 1, more specifically, to a substrate provided in the actuator 3.

When power is supplied to the coil portion 520, electromagnetic force may be generated between the magnet portion 510 and the coil portion 520. The electromagnetic force may serve as driving force for rotating the rotator 300.

A position sensor 530 may be disposed on the substrate 540, together with the coil portion 520.

The position sensor 530 may be disposed to oppose at least one of the first magnet 511 and the second magnet 512 in the optical axis direction (Z-axis direction), and may detect a change in the magnetic field to detect a position of the rotator 300. For example, the position sensor 530 may be provided as a Hall sensor.

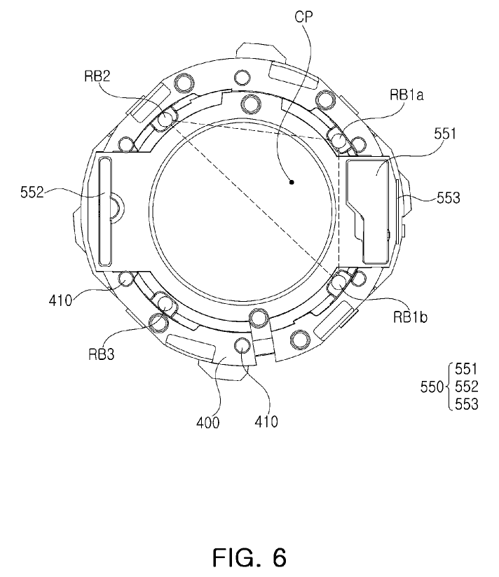

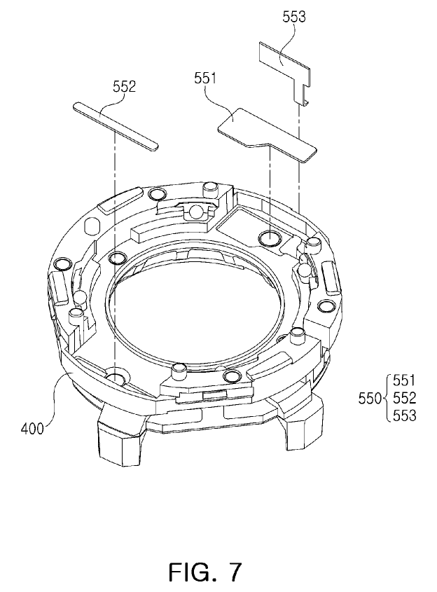

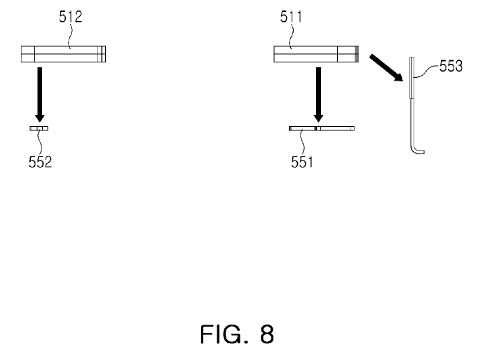

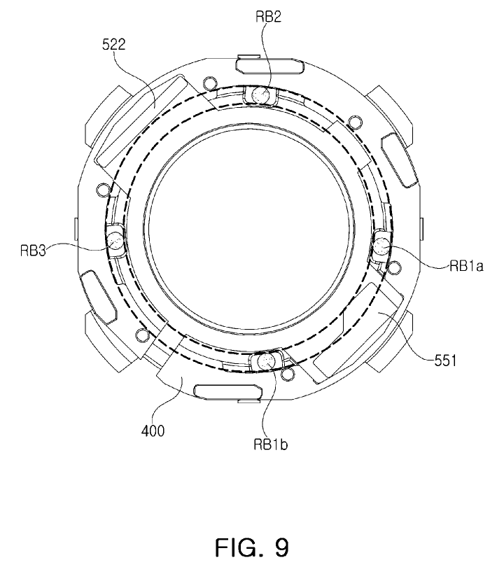

FIG. 6 is a plan view of a ball rolling portion of the iris module of FIG. 4. FIG. 7 is a perspective view of a yoke portion separated from a base of FIG. 4. FIG. 8 is a diagram illustrating a direction of attractive force of the iris module of FIG. 4. FIG. 9 is a plan view of a ball rolling portion and a guide groove in which the ball rolling portion is disposed.

A ball rolling portion RB may be disposed between the rotator 300 and the base 400.

The ball rolling portion RB may reduce friction by rolling in a rotational direction of the rotator 300 during rotation.

The ball rolling portion RB may include a plurality of ball members spaced apart from each other in a circumferential direction of the base 400 (or the rotator 300). For example, the ball rolling portion RB may include three or more ball members. In an example embodiment, the ball rolling portion RB may include four ball members, as illustrated in FIG. 6.

A pulling yoke portion 550 may be disposed on the base 400. For example, the pulling yoke portion 550 may be provided on the base 400 in an inserted form.

The pulling yoke portion 550 may be disposed in a position opposing a position of the magnet portion 510 in the optical axis direction (Z-axis direction). For example, the pulling yoke portion 550 may include a first pulling yoke 551 opposing the first magnet 551 in the optical axis (Z-axis) direction, and a second pulling yoke 552 opposing the second magnet 552 in the optical axis (Z-axis) direction.

The pulling yoke portion 550 may be formed of a magnetic material, and may generate attractive force with the magnet portion 510. Due to attractive force between the pulling yoke portion 550 and the magnet portion 510, the ball rolling portion RB may maintain contact with the rotator 300 and the base 400.

The ball rolling portion RB may include a first ball member RB1, a second ball member RB2, and a third ball member RB3 spaced apart from each other in the circumferential direction of the base 400.

The first to third ball members RB1 to RB3 may include one or more balls. For example, the number of balls included in the first ball member RB1 may be greater than the number of balls included in the second ball member RB2 and the third ball member RB3.

The first ball member RB1 may include two balls (hereinafter, a first ball RB1a and a second ball RB1b), and the second and third ball members RB2 and RB3 may respectively include one ball.

The first ball member RB1, that is, the first ball RB1a and the second ball RB1b, may be disposed around the first magnet 511, and the second ball member RB2 may be disposed around the second magnet 512. A position of the third ball member RB3 is not limited.

The base 400 and the rotator 300 may include a guide groove portion in which the ball rolling portion RB is disposed. For example, the base 400 may include a first guide groove portion 420, and the rotator 300 may include a second guide groove portion 320.

The first guide groove portion 420 and the second guide groove portion 320 may oppose each other in the optical axis direction (Z-axis direction), and the ball rolling portion RB may be disposed between the first guide groove portion 420 and the second guide groove portion 320.

The number of first guide groove portions 420 and second guide groove portions 320 may correspond to the number of balls included in the ball rolling portion RB.

In an example embodiment, the first guide groove portion 420 and the second guide groove portion 320 may respectively include four guide grooves. Balls included in the first to third ball members RB1 to RB3 may be individually accommodated in the guide grooves.

The first ball member RB1 disposed around the first magnet 511, that is, the first ball RB1a and the second ball RB1b may serve as a main guide. The first ball RB1a and the second ball RB1b may be in two-point contact with respective guide grooves.

The second ball member RB2 may serve as an auxiliary guide. The second ball member RB2 may be in one-point or two-point contact with respective guide grooves.

The third ball member RB3 may serve to prevent tilting of the rotator 300. The third ball member RB3 may be in one-point or two-point contact with respective guide grooves. The third ball member RB3 may be optionally provided.

Referring to FIG. 6, the rotator 300 may be supported at three points on the base 400 by the first ball member RB1 and the second ball member RB2.

A central point CP of attractive force acting on a space between the magnet portion 510 and the pulling yoke portion 550 may be positioned in a support region formed by connecting contact points between the first and second ball member RB1, RB2 and the rotator 300 (or the base 400), such that the rotator 300 may be stably driven.

In addition, sizes of the first pulling yoke 551 and the second pulling yoke 552 may be configured to be different from each other, the central point CP of attractive force may be positioned close to the first ball member RB1, which serves as a main guide.

When attractive force acting on a space between the first magnet 511 and the first pulling yoke 551 is greater than attractive force acting on a space between the second magnet 512 and the second pulling yoke 552, the central point CP of attractive force may be positioned on the side of the first ball member RB1.

Accordingly, in addition to the above example, the center point CP of attractive force may be positioned on the side of the first ball member RB1 by configuring sizes of the first magnet 511 and the second magnet 512 to be different from each other, or by configuring a distance between the first magnet 511 and the first pulling yoke 551 and a distance between the second magnet 512 and the second pulling yoke 552 to be different from each other.

Referring to FIG. 7, the pulling yoke portion 550 may further include an auxiliary yoke 553 disposed on a side of the first magnet 511.

The auxiliary yoke 553 may also be provided on the base 400 in an inserted form, and may be formed of a magnetic material.

The first magnet 511 may oppose the first pulling yoke 551 in the optical axis direction (Z-axis direction), and may oppose the auxiliary yoke 553 in a direction, intersecting the optical axis (Z-axis).

That is, attractive force may act on the first magnet 511 in a direction, opposing the first pulling yoke 551, and in a direction opposing the auxiliary yoke 553.

The auxiliary yoke 553 may assist functions of the first pulling yoke 551 and the second pulling yoke 552.

The descriptions of the iris driving portion 500 and related components are not limited to the example embodiments described above.

As described above, the present disclosure may be characterized by a coupling structure between the first spacer 110 and the rotator 300.

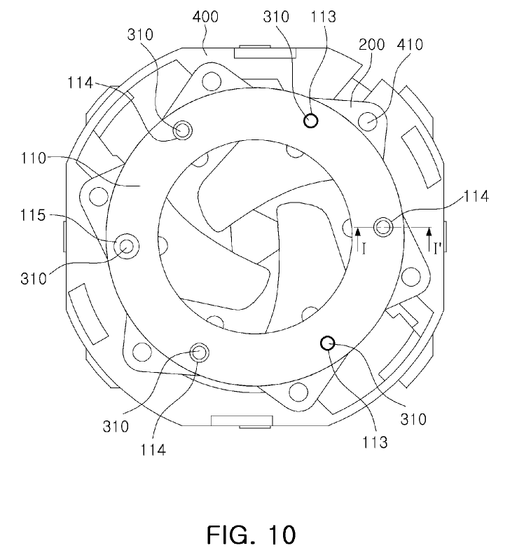

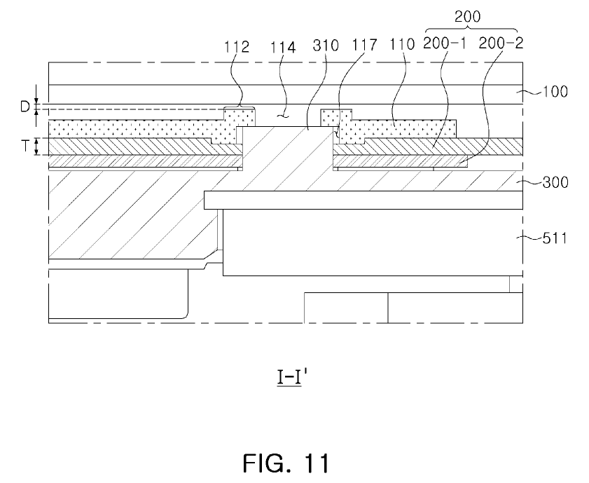

FIG. 10 is a plan view of an iris module (with a cover omitted) according to an example embodiment of the present disclosure. FIG. 11 is a cross-sectional view taken along line I–I' of FIG. 10.

The first spacer 110 may be a ring-shaped member having an inner diameter and an outer diameter. The outer diameter of the first spacer 110 may determine a size of the first spacer 110, and the inner diameter of the first spacer 110 may define the through-hole 111.

The first spacer 110 may overlap the blade 200 in a region between the outer diameter and the inner diameter.

The first spacer 110 may include a plurality of coupling holes. The plurality of coupling holes may be provided in positions spaced apart from each other in a circumferential direction of the first spacer 110 and may be formed in positions corresponding to those of guide protrusions 310.

The number of the plurality of coupling holes may correspond to the number of guide protrusions 310, or may be less than the number of guide protrusions 310.

According to an example embodiment of the present disclosure, the number of coupling holes included in the first spacer 110 may correspond to the number of guide protrusions 310. For example, the rotator 300 may include six guide protrusions 310, and the first spacer 110 may include six coupling holes.

The first spacer 110 may include coupling holes having different sizes. For example, the first spacer 110 may include a first coupling hole 113, a second coupling hole 114, and a third coupling hole 115 having different diameters.

Referring to FIG. 10, the first coupling hole 113 may have a diameter (first diameter) approximately equal to that of the guide protrusion 310. Accordingly, the guide protrusion 310 may be properly fitted into the first coupling hole 113. The first coupling hole 113 may be provided as a plurality of first coupling holes 113.

The second coupling hole 114 may have a diameter (second diameter) less than that of the guide protrusion 310. Accordingly, the guide protrusion 310 may not pass through the second coupling hole 114. The second coupling hole 114 may be provided as a plurality of second coupling holes 114.

Referring to FIG. 11, the first spacer 110 may include an extension portion 112 extending to an upper side of the guide protrusion 310, and thus may be seated on the guide protrusion 310.

The extension portion 112 may define the second coupling hole 114. The extension portion 112 may be disposed to overlap the guide protrusion 310 in the optical axis direction (Z-axis direction). Accordingly, the second coupling hole 114 defined by the extension portion 112 may have a diameter less than that of the guide protrusion 310.

The extension portion 112 may be in contact with the guide protrusion 310. For example, a lower surface of the extension portion 112 may be in contact with an upper surface of the guide protrusion 310.

An adhesive (not illustrated) may be coated on a space between the extension portion 112 and the guide protrusion 310.

In a position in which the second coupling hole 114 is formed, the first spacer 110 and the guide protrusion 310 may have a distance therebetween in a direction perpendicular to the optical axis (Z-axis). A separation region 117 may be formed between the guide protrusion 310 and the first spacer 110 along an outer circumference of the guide protrusion 310. The above-described distance may correspond to the separation region 117.

The adhesive coated on a space between the extension portion 112 and the guide protrusion 310 may be accommodated in the separation space 117. Overflow of the adhesive may be prevented through the separation space 117.

The third coupling hole 115 may have a diameter (third diameter) greater than that of the guide protrusion 310. Accordingly, the guide protrusion 310 may pass through the third coupling hole 115, and a distance may be formed between the guide protrusion 310 and the first spacer 110 at an edge of the third coupling hole 115 in a direction perpendicular to the optical axis (Z-axis). The third coupling hole 115 may be provided as one or more third coupling holes 115.

According to an example embodiment, among coupling holes provided in the first spacer 110, the third coupling hole 115 may have a largest diameter, and the second coupling hole 114 may have a smallest diameter. In addition, among the coupling holes provided in the first spacer 110, the second coupling hole 114 may be provided in the greatest number, and the third coupling hole 115 may be provided in the smallest number.

For example, the first spacer 110 may include three second coupling holes 114, two first coupling holes 113, and one third coupling hole 115. The second coupling holes 114 may be disposed to be spaced apart from each other, and the first coupling holes 113 and the third coupling hole 115 may be disposed between the second coupling holes 114.

According to an example embodiment of the present disclosure, the first coupling hole 113 of the first spacer 110 may be properly fitted to the guide protrusion 310 to restrict movement of the first spacer 110 in the direction perpendicular to the optical axis (Z-axis). The second coupling hole 114 of the first spacer 110 may overlap the guide protrusion 310 in the optical axis direction (Z-axis direction) to restrict movement of the first spacer 110 in the optical axis direction (Z-axis direction). The third coupling hole 115 of the first spacer 110 may have a distance with the guide protrusion 310 in the direction perpendicular to the optical axis (Z-axis), thereby compensating for assembly tolerances between the first spacer 110 and the rotator 300.

A distance (D) may be formed between the first spacer 110 and the cover 100 in the optical axis direction (Z-axis direction), and the distance (D) may be less than a thickness (T) of each of the blades 200-1, 200-2.

For example, when a surface of the first spacer 110 toward the cover 100 includes a step portion, the distance (D) may refer to a shortest distance between the first spacer 110 and the cover 100. In addition, the thickness (T) of the blade 200 may refer to a thickness of the blade 200 in the optical axis direction (Z-axis direction).

According to an example embodiment, even when the first spacer 110 is separated from the guide protrusion 310, a distance formed between the first spacer 110 and the guide protrusion 310 may be less than the thickness (T) of the blade 200 itself due to separation of the first spacer 110 from the guide protrusion 310, such that the blade 200 may not be detached from the guide protrusion 310.

A distance formed between the first spacer 110 and the guide protrusion 310 in the optical axis direction (Z-axis direction) in a state in which the first spacer 110 is separated from the guide protrusion 310, may be approximately equal to the distance (D) formed between the first spacer 110 and the cover 100 in the optical axis direction (Z-axis direction) in a state in which the first spacer 110 is seated on the guide protrusion 310.

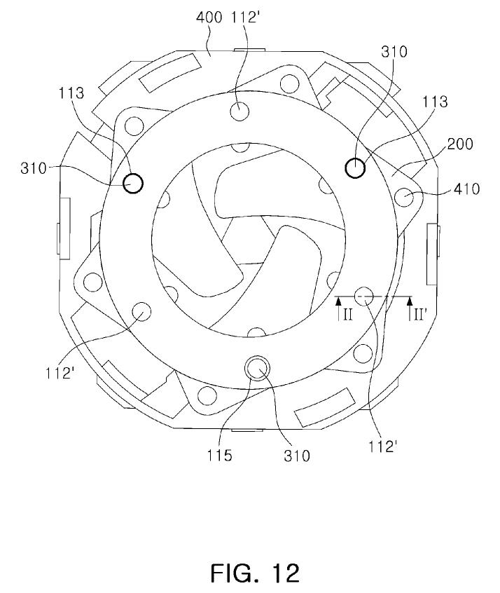

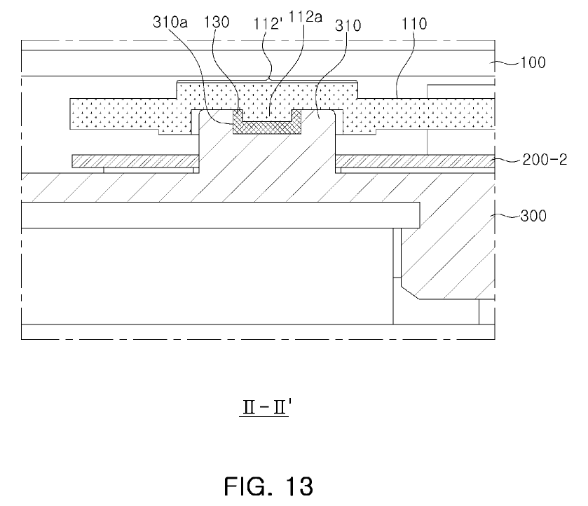

FIG. 12 is a plan view of an iris module (with a cover omitted) according to another example embodiment of the present disclosure. FIG. 13 is a cross-sectional view taken along line II–II' of FIG. 12.

Referring to FIG. 12, the number of coupling holes included in a first spacer 110 may be less than the number of guide protrusions 310.

The first spacer 110 may include a first coupling hole 113 having a diameter substantially equal to that of the guide protrusion 310 according to the above-described example embodiment, and a third coupling hole 115 having a diameter greater than that of the guide protrusion 310. For example, the first spacer 110 may include two first coupling holes 113 and one third coupling hole 115, and the coupling holes may be formed in positions corresponding to positions of the guide protrusions 310.

According to another example embodiment of the present disclosure, the first spacer 110 may include an extension portion 112' in a position in which the second coupling hole 114 according to the above-described example embodiment is provided.

In another example embodiment, the extension portion 112' may be formed to cover the entire guide protrusion 310.

An adhesive 130 may be coated on a space between the extension portion 112' and the guide protrusion 310.

Referring to FIG. 13, a lower surface of the extension portion 112', opposing the guide protrusion 310 in an optical axis direction (Z-axis direction), may include a coupling protrusion 112a protruding toward the guide protrusion 310. An upper surface of the guide protrusion 310, opposing the extension portion 112' in the optical axis (Z-axis) direction, may include a coupling groove 310a. The coupling protrusion 112a may be accommodated in the coupling groove 310a.

The coupling groove 310a may have a width and depth greater than a width and height of the coupling protrusion 112a. Accordingly, when the coupling protrusion 112a is accommodated in the coupling groove 310a, a separation space may be formed between the coupling groove 310a and the coupling protrusion 112a in the optical axis direction (Z-axis direction) and in a direction perpendicular to an optical axis (Z-axis).

An adhesive 130 for coupling the first spacer 110 and the rotator 300 to each other may be disposed in the separation space. For example, after the adhesive 130 is coated on the coupling groove 310a, the coupling protrusion 112a may be positioned in the coupling groove 310a, and thermal curing may be performed.

The coupling groove 310a may have a relatively sufficient width and depth, as compared to the coupling protrusion 112a, such that the adhesive 130 may not overflow to the surroundings thereof.

In a modification, positions of the coupling protrusion 112a and the coupling groove 310a may be switched.

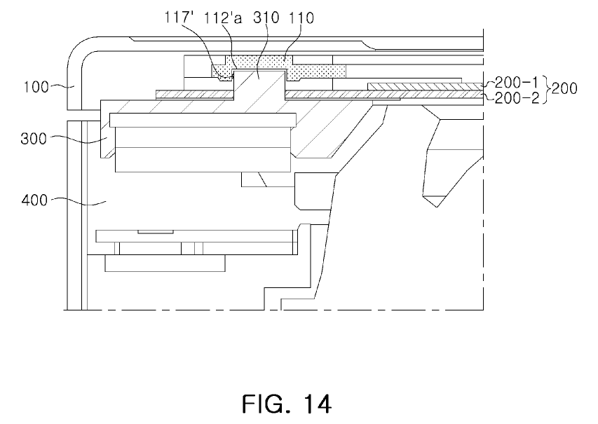

Referring to FIG. 14, a lower surface of an extension portion 112', opposing the guide protrusion 310 in the optical axis direction (Z-axis direction), may include a coupling groove 112'a. The guide protrusion 310 may be accommodated in the coupling groove 112'a.

A separation space 117' may be formed between the coupling groove 112'a and the guide protrusion 310, and an adhesive may be coated on the separation space 117'.

According to the present disclosure, the risk of component detachment may be reduced or eliminated.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An iris module comprising:
a base;
a rotator disposed on one side of the base;
a plurality of blades disposed on one side of the rotator and defining an entrance aperture; and
a first spacer disposed on one side of the plurality of blades and coupled to the rotator,
wherein the rotator comprises a plurality of guide protrusions to which the plurality of blades are coupled, respectively, and
wherein the first spacer overlaps some guide protrusions, among the plurality of guide protrusions, in an optical axis direction.

2. The iris module of claim 1, wherein the first spacer comprises a plurality of coupling holes formed in positions corresponding to the plurality of guide protrusions.

3. The iris module of claim 2, wherein the number of the plurality of coupling holes corresponds to the number of the plurality of guide protrusions, or is less than the number of the plurality of guide protrusions.

4. The iris module of claim 2, wherein
the plurality of coupling holes comprise:
a first coupling hole comprising a first diameter; and
a second coupling hole comprising a second diameter, and
the second diameter is greater than the first diameter and a diameter of each of the plurality of guide protrusions.

5. The iris module of claim 4, wherein
the first spacer comprises an extension portion extending from the first spacer to one side of the guide protrusion, and
the extension portion overlaps a portion of the guide protrusion in the optical axis direction.

6. The iris module of claim 5, wherein
the plurality of coupling holes further comprise a third coupling hole defined by the extension portion and having a third diameter, and
the third diameter is less than the first diameter and the diameter of each of the plurality of guide protrusions.

7. The iris module of claim 6, wherein, among the first coupling hole, the second coupling hole, and the third coupling hole, the third coupling hole is provided in the greatest number, and the second coupling hole is provided in the smallest number.

8. The iris module of claim 5, wherein the extension portion is formed to cover the guide protrusion entirely.

9. The iris module of claim 1, further comprising:
a cover disposed on one side of the first spacer,
wherein a distance between the cover and the first spacer in the optical axis direction is less than a thickness in the optical axis direction of each of the plurality of blades.

10. The iris module of claim 1, wherein
the plurality of blades comprise an upper blade set and a lower blade set, disposed at different heights in the optical axis direction, and
the first spacer is disposed on one side of the upper blade set.

11. The iris module of claim 10, further comprising:
a second spacer disposed between the lower blade set and the rotator.

12. The iris module of claim 1, wherein
the plurality of blades are coupled to the base and the rotator, respectively,
the rotator is configured to be rotatable about an optical axis relative to the base, and
the plurality of blades are configured to adjust a size of the entrance aperture in response to rotation of the rotator.

13. An iris module comprising:
a base;
a rotator supported by the base and configured to be rotatable, relative to the base;
a plurality of blades coupled to the base and the rotator, respectively; and
a first spacer coupled to the rotator and disposed to overlap the plurality of blades,
wherein the rotator comprises a plurality of guide protrusions to which the plurality of blades and the first spacer are coupled, and
wherein the first spacer comprises a plurality of coupling holes formed in positions corresponding to the plurality of guide protrusions and comprising different diameters.

14. The iris module of claim 13, wherein the number of the plurality of coupling holes corresponds to the number of the plurality of guide protrusions, or is less than the number of the plurality of guide protrusions.

15. The iris module of claim 13, wherein
the plurality of coupling holes comprise:
a first coupling hole comprising a first diameter;
a second coupling hole comprising a second diameter; and
a third coupling hole comprising a third diameter,
wherein the second diameter is greater than the first diameter and a diameter of each of the plurality of guide protrusions, and
the third diameter is less than the first diameter and the diameter of each of the plurality of guide protrusions.

16. A camera module comprising:
the iris module of claim 1; and
an actuator comprising a lens module and configured to be movable in at least one direction among the optical axis direction and a direction perpendicular to an optical axis.

17. The camera module of claim 16, wherein the iris module is coupled to the actuator and configured to move together with the actuator.
